(19) United States
(12) Patent Application Publication
(10) Pub. No.: US 2026/0145125 A1
(43) Pub. Date: May 28, 2026

(54) GAS CAPTURING DEVICE

(71) Applicant: Metal Industries Research & Development Centre, Kaohsiung (TW)

(72) Inventors: Po-Wei Pan, Kaohsiung City (TW); Chia-Hsun Li, Kaohsiung City (TW); Chih-Yung Wu, Tainan City (TW); Sheng-Chung Yang, Kaohsiung City (TW)

(73) Assignee: Metal Industries Research & Development Centre, Kaohsiung (TW)

(21) Appl. No.: 18/959,691

(22) Filed: Nov. 26, 2024

(51) Int. Cl. B01D 53/62; B01D 53/82; B01J 20/22; B01J 20/28

(52) U.S. Cl. CPC B01D 53/62; B01D 53/82; B01J 20/226; B01J 20/28035; B01D 2253/204; B01D 2257/504

(57) ABSTRACT

A gas capturing device includes an inlet pipe cover, an outlet pipe cover, a chamber connected between the inlet pipe cover and the outlet pipe cover, a plurality of gas adsorption modules arranged with each other in a stacked manner in the chamber, and a gas distribution mechanism disposed between the inlet pipe cover and the chamber. A gas flow enters the chamber from the inlet pipe cover, moves through the gas adsorption modules, and enters the outlet pipe cover from the chamber after a specific gas of the gas flow is adsorbed by the gas adsorption modules. The gas distribution mechanism includes two gas distribution plates stacked together along a flow direction of the gas flow. Each gas distribution plate has a plurality of holes, and the holes are dislocated from each other along the flow direction of the gas flow.

### BACKGROUND

### Technical Field

The disclosure relates to a gas capturing device, and particularly relates to a gas capturing device with a uniformized flow field.

### Description of Related Art

Rising atmospheric carbon concentrations have been linked to industrial activity for decades. Carbon dioxide is the major contributor to total carbon concentration. Concerns about global warming have led to interest in capturing carbon dioxide emissions.

Metal-organic frameworks (MOFs) are a new material known to be developing rapidly. The MOFs have high porosity, high specific surface area and structural tunability, and have been widely used in the field of gas adsorption and separation. The pore size of the MOF materials ranges from 0.5 nanometers to several nanometers, so it may block particles with a particle size larger than its pore size. For example, carbon dioxide may be directly utilized from waste gas containing a large amount of impurities, thus saving production costs and energy and contributing to the development of green economy.

However, the adsorption efficiency of the MOF materials will be affected by pipeline gas flow. For example, due to the influence of the boundary layer, the gas flow in the flue system causes differences in the flow rate of the gas flow at the same cross-section. When the inner diameter of the pipeline changes, the differences in the flow rate will further increase. As a result, in the reaction chamber equipped with the MOF materials, the uneven flow rate of the gas flow will greatly reduce the adsorption efficiency of carbon dioxide.

### SUMMARY

The disclosure provides a gas capturing device that may effectively uniformize a gas flow in a reaction chamber and contribute to the capture efficiency of a gas adsorption module for a specific gas.

A gas capturing device of the disclosure includes an inlet pipe cover, an outlet pipe cover, a chamber, a plurality of gas adsorption modules, and a gas distribution mechanism. The chamber is connected between the inlet pipe cover and the outlet pipe cover. The gas adsorption modules are arranged with each other in a stacked manner in the chamber. A gas flow enters the chamber from the inlet pipe cover, moves through the gas adsorption modules, and enters the outlet pipe cover from the chamber after a specific gas of the gas flow is adsorbed by the gas adsorption modules. The gas distribution mechanism is disposed between the inlet pipe cover and the chamber. The gas distribution mechanism includes two gas distribution plates stacked together along a flow direction of the gas flow. Each gas distribution plate has a plurality of holes, and the holes are dislocated from each other along the flow direction of the gas flow.

In an embodiment of the disclosure, each of the above-mentioned gas adsorption modules is plate-shaped and parallel to the flow direction of the gas flow, and the gas distribution plates are perpendicular to the flow direction of the gas flow.

In an embodiment of the disclosure, the above-mentioned hole is a circular hole, and a diameter (D1) is 9.5 mm to 12.7 mm.

In an embodiment of the disclosure, a dislocation distance between the corresponding two holes of the two gas distribution plates is 0.7 times the diameter (D1) to 1 times the diameter (D1).

In an embodiment of the disclosure, a relative distance between the two gas distribution plates is 4.7 times the diameter (D1) to 6.3 times the diameter (D1).

In an embodiment of the disclosure, the above-mentioned holes are non-circular holes, and an area of each hole is equal to an area of a circular hole with a diameter (D1) of 9.5 mm to 12.7 mm.

In an embodiment of the disclosure, the gas adsorption module is of a metal-organic framework (MOF) material.

In an embodiment of the disclosure, one end of the above-mentioned inlet pipe cover connected to the gas distribution mechanism gradually expands along the flow direction of the gas flow.

In an embodiment of the disclosure, one end of the outlet pipe cover connected to the chamber gradually contracts along the flow direction of the gas flow.

In an embodiment of the disclosure, the above-mentioned hole is a through hole of equal diameter.

Based on the above, the gas capturing device provides the gas adsorption modules in the chamber to facilitate the capture of a specific gas, and also further considers its gas capture efficiency and disposes the gas distribution mechanism between the inlet pipe cover and the chamber to adjust the flow field of the gas flow entering the chamber from the inlet pipe cover. The gas distribution mechanism is composed of two gas distribution plates stacked with each other, each gas distribution plate has a plurality of holes, and in the flow direction of the gas flow, the holes of one of the gas distribution plates are dislocated relative to the holes of the other gas distribution plate. In this way, the gas flow that was originally affected by the pipelines and showed uneven flow rate may be re-adjusted through the two gas distribution plates, so that the flow field (i.e., flow rate) of the gas flow entering the chamber may be effectively uniformized, thereby allowing the gas flow in the chamber to move through the gas adsorption modules stably and at a uniform speed, and improving the gas capture efficiency of the gas adsorption modules.

### BRIEF DESCRIPTION OF THE DRAWINGS

FIG. 1 is a partial cross-sectional diagram of a gas capturing device according to an embodiment of the disclosure.

FIG. 2 is a side view diagram of the part shown in FIG. 1.

FIG. 3 shows a corresponding relationship between the holes of the two gas distribution plates.

FIG. 4A and FIG. 4B are respectively streamline diagrams in the chamber.

FIG. 5A to FIG. 5C are respectively streamline diagrams in the chamber.

### DESCRIPTION OF THE EMBODIMENTS

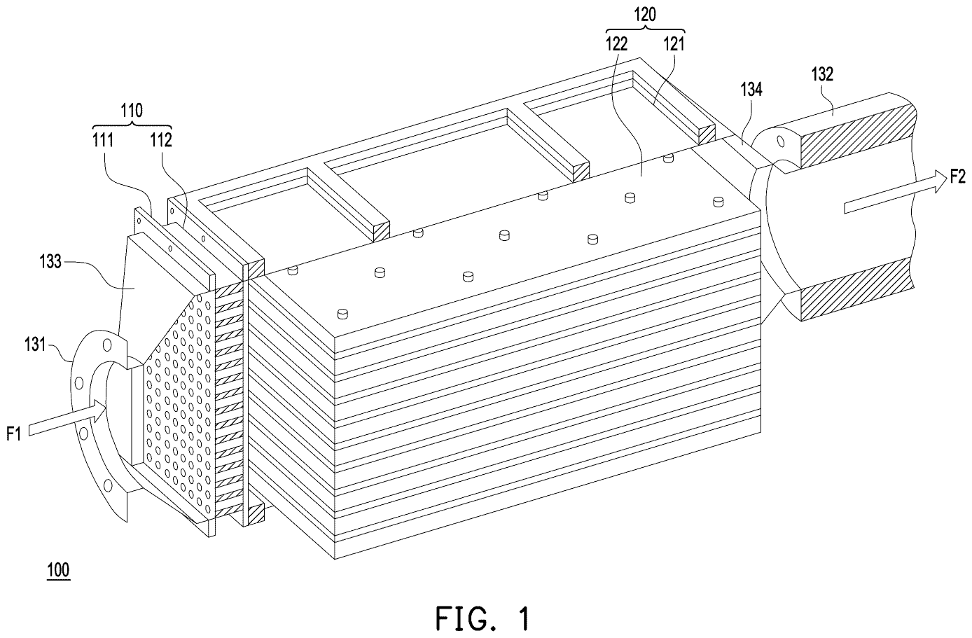

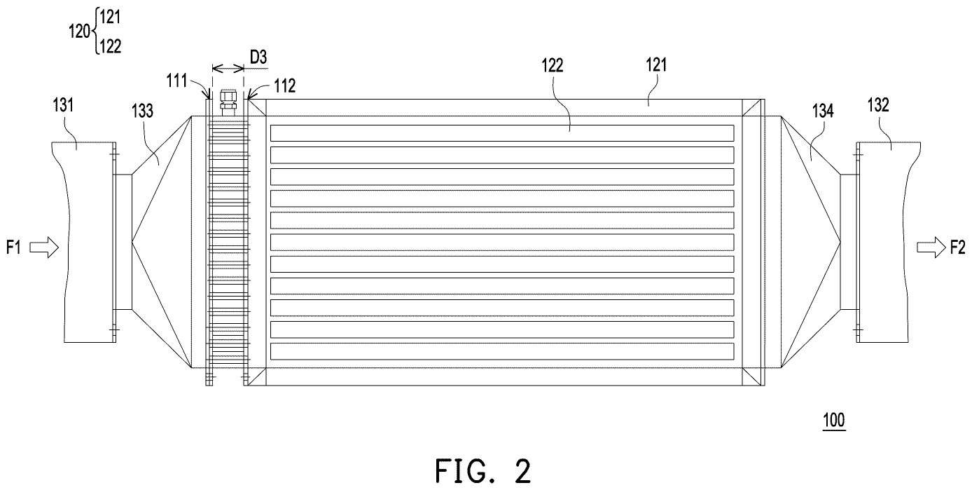

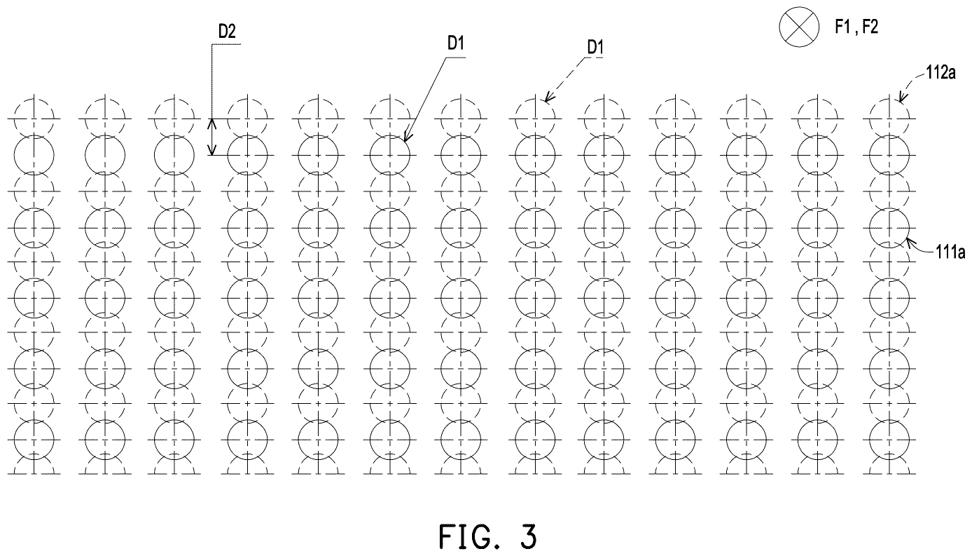

FIG. 1 is a partial cross-sectional diagram of a gas capturing device according to an embodiment of the disclosure. FIG. 2 is a side view diagram of the part shown in FIG. 1. FIG. 3 shows a corresponding relationship between the holes of the two gas distribution plates. Referring to FIG. 1 to FIG. 3 at the same time, in the embodiment, a gas capturing device 100 is, for example, adapted to a flue system for gas filtration. The gas capturing device 100 includes an inlet pipe 131, an outlet pipe 132, an inlet pipe cover 133, an outlet pipe cover 134, a reaction chamber 120, and a gas distribution mechanism 110. The reaction chamber 120 includes a chamber 121 and a plurality of gas adsorption modules 122 disposed therein. The chamber 121 is connected between the inlet pipe cover 133 and the outlet pipe cover 134. The inlet pipe cover 133 is connected between the inlet pipe 131 and the gas distribution mechanism 110, and the outlet pipe cover 134 is connected between the chamber 121 and the outlet pipe 132. The gas distribution mechanism 110 is disposed between the inlet pipe cover 133 and the chamber 121. The gas adsorption modules 122 are arranged with each other in a stacked manner in the chamber 121. A gas flow F1 moves through the inlet pipe cover 133 and the gas distribution mechanism 110 from the inlet pipe 131 and enters the chamber 121, and after a specific gas of the gas flow F1 is adsorbed by the gas adsorption modules 122, a gas flow F2 then enters the outlet pipe 132 from the chamber 121 through the outlet pipe cover 134, thereby completing the removal process (adsorption reaction) of the specific gas of the gas flow F1 in the reaction chamber 120. Here, the arrows shown as gas flow F1 and gas flow F2 represent the flow direction of the gas flow in the gas capturing device 100.

In another embodiment not shown, the gas capturing device 100 may perform a desorption reaction on the gas adsorption modules 122 that have adsorbed the specific gas through a reverse reaction. The flow direction of the gas flow is still as shown in FIG. 1. The difference is that the gas flow entering the chamber 121 does not contain the specific gas. The gas adsorption modules 122 in the chamber 121 is used to release the specific gas, so that the gas flow leaving the chamber 121 contains the specific gas.

Whether it is the adsorption reaction shown in FIG. 1 or the aforementioned desorption reaction, what remains unchanged in the embodiment is that the gas flow before entering the chamber 121 needs to be adjusted by the gas distribution mechanism 110 for flow field adjustment. In the embodiment, the gas distribution mechanism 110 includes two gas distribution plates 111 and 112, which are stacked together along the flow direction of the gas flow F1 (or F2). Each of the gas distribution plates 111 and 112 has a plurality of holes 111a and 112a, and as shown in FIG. 3, at this time, the flow directions of the gas flows F1 and F2 are to enter the paper surface, and the holes 111a and 112a are dislocated from each other along the flow directions of the gas flows F1 and F2.

Furthermore, as shown in FIG. 1 or FIG. 2, each gas adsorption module 122 is of a plate-shaped metal-organic framework (MOF) material to facilitate the adsorption of carbon dioxide, and is parallel to the flow directions of the gas flows F1 and F2, the gas distribution plates 111 and 112 are perpendicular to the flow directions of the gas flows F1 and F2. The gas flow F1 entering the chamber 121 will move along the gaps between the gas adsorption modules 122, and in the process of moving through the gas adsorption modules 122, the specific gas of the gas flow F1 will be adsorbed by the gas adsorption modules 122, or, as in the aforementioned desorption process, the gas adsorption modules 122 are driven to release a specific gas in the process of moving through the gas adsorption modules 122.

Furthermore, as shown in FIG. 1 or FIG. 2, the pipe diameter (or the cross-sectional area) of the inlet pipe 131 is smaller than the inner diameter (or the cross-sectional area) of the chamber 121, and the pipe diameter (or the cross-sectional area) of the outlet pipe 132 is also smaller than the inner diameter (or the cross-sectional area) of the chamber 121. Therefore, one end of the inlet pipe cover 133 connected to the gas distribution mechanism 110 gradually expands along the flow directions of the gas flows F1 and F2, while one end of the outlet pipe cover 134 connected to the chamber 121 gradually contracts along the flow directions of the gas flows F1 and F2. As a result, the boundary layer characteristics of the gas flow F1 will increase its flow rate difference due to changes in pipe diameter (cross-sectional area). Accordingly, adjusting the flow field of the gas flow F1 entering the chamber 121 through the gas distribution mechanism 110 will be beneficial to making the flow field of the gas flow F1 in the chamber 121 uniformized.

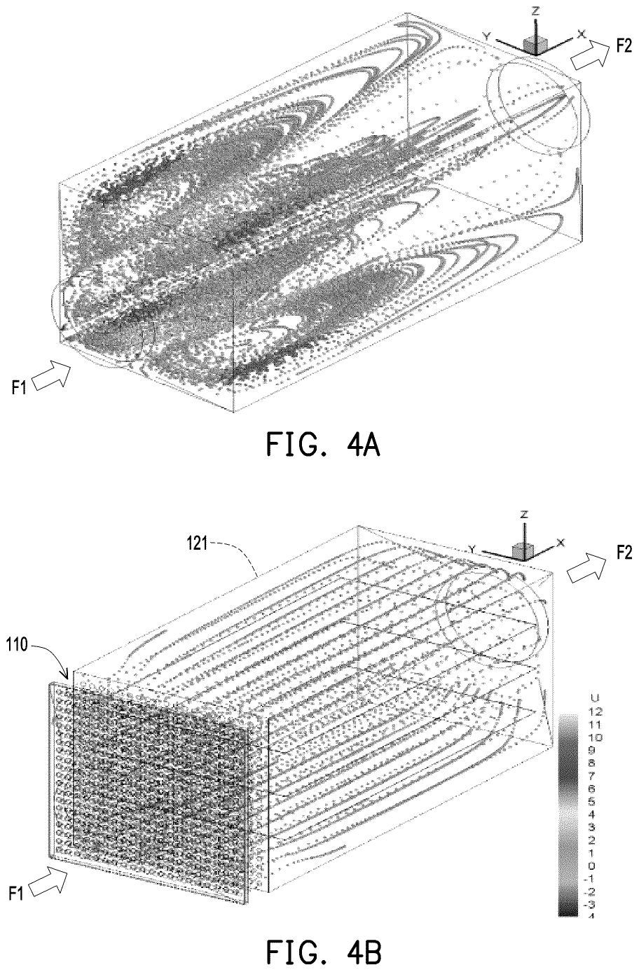

FIG. 4A and FIG. 4B are respectively streamline diagrams in the chamber. FIG. 4A is a flow field simulation diagram of the gas capturing device 100 without the gas distribution mechanism 110, and FIG. 4B is a flow field simulation diagram of the gas capturing device 100 with the gas distribution mechanism 110. Please refer to FIG. 4A and FIG. 4B at the same time to have a more obvious understanding of the uniformity produced by the aforementioned gas distribution mechanism 110. As shown in FIG. 4A, when the gas distribution mechanism 110 is not configured, the gas flow entering the chamber 121 obviously causes uneven flow rate due to the boundary layer effect and further generates a vortex. When the gas distribution mechanism 110 is configured as in the embodiment, as shown in FIG. 4B, the flow field of the gas flow F1 is obviously uniformized, and therefore the generation of vortex is avoided. At the same time, the uniformization of the flow field may also help prevent the temperature of the gas flow F1 in the chamber 121 from changing drastically or having significant differences depending on the location. Here, by comparing FIG. 4A and FIG. 4B, the benefits produced by the gas distribution mechanism 110 may be clearly understood.

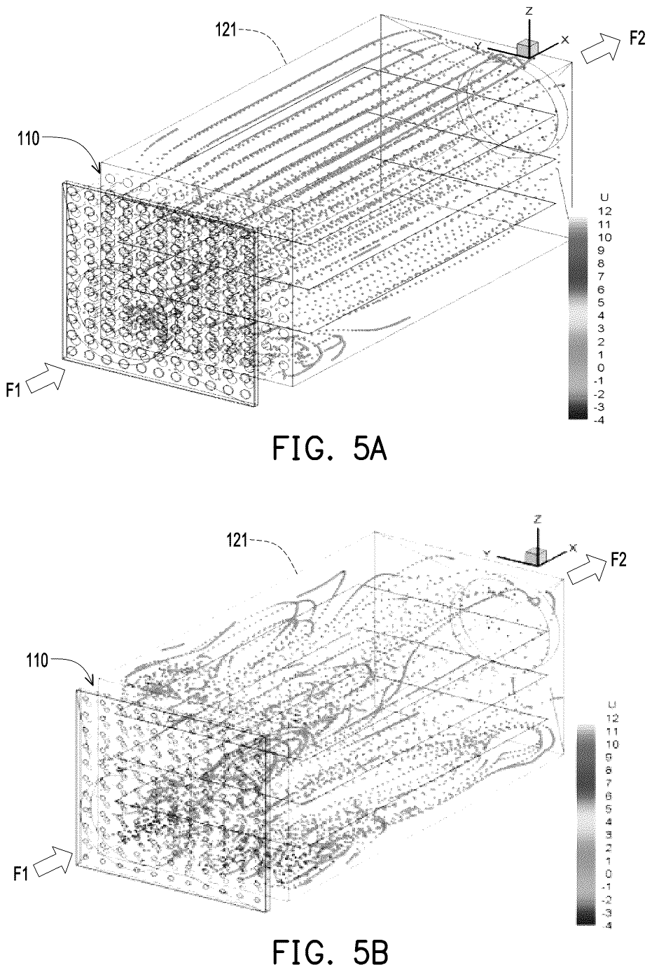

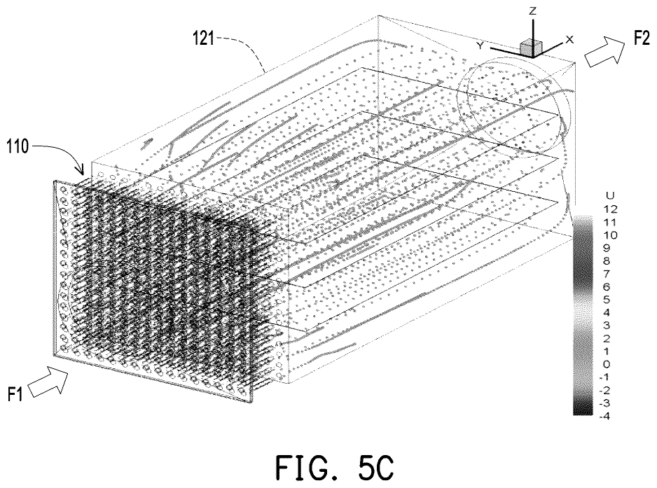

FIG. 5A to FIG. 5C are respectively streamline diagrams in the chamber, which respectively reflect the corresponding streamline changes when the relevant parameters of the gas distribution plates 111 and 112 and their holes 111a and 112a thereon are changed through flow field simulation. Referring to FIG. 3, FIG. 4B, and FIG. 5A first, in the embodiment, the holes 111a and 112a on the gas distribution plates 111 and 112 are circular through holes of equal diameter respectively, and a hole diameter D1 is preferably 9.5 mm to 12.7 mm, thereby forming the flow field streamline diagram shown in FIG. 4B. On the other hand, when the hole diameter D1 is greater than 12.7 mm or less than 9.5 mm, a flow field streamline diagram as shown in FIG. 5A will be generated, and there is still an obvious vortex generated when the gas flow F1 just leaves the gas distribution mechanism 110.

In another embodiment not shown, the holes of the gas distribution plates 111 and 112 may be non-circular holes. By simply making the hole area of the non-circular hole equal to the area of the circular hole mentioned above (FIG. 3) (that is, let the hole area of the non-circular hole be equal to the area of the circular hole with a diameter D1 of 9.5 mm to 12.7mm), a uniformizing effect on the gas flow in the chamber 121 may be generated.

Furthermore, referring to FIG. 3, FIG. 4B, and FIG. 5B at the same time, in the embodiment, a dislocation distance D2 between the corresponding two holes 111a and 112a of the two gas distribution plates 111 and 112 is preferably 0.7 times the diameter D1 to 1 times the diameter D1, that is, 0.7*(D1)≤D2≤1*(D1), thereby forming a flow field streamline diagram as shown in FIG. 4B. On the other hand, when (D2)<0.7*(D1) or when (D2)>1*(D1), as shown in FIG. 5B, a vortex is generated in the chamber 121.

In addition, referring to FIG. 2, FIG. 4B, and FIG. 5C at the same time, in the embodiment, a relative distance D3 between the two gas distribution plates is 4.7 times the diameter D1 to 6.3 times the diameter D1, that is, 4.7*(D1)≤D3≤6.3*(D1), thereby forming the flow field streamline diagram as shown in FIG. 4B. On the other hand, when (D3)<4.7*(D1) or when (D3)>6.3*(D1), as shown in FIG. 5C, an unstable flow field is generated on the inner wall of the chamber 121.

In summary, in the above-mentioned embodiments of the disclosure, the gas capturing device provides the gas adsorption modules in the chamber to facilitate the capture of a specific gas, and also further considers its capture efficiency and disposes the gas distribution mechanism between the inlet pipe cover and the chamber to adjust the flow field of the gas flow entering the chamber from the inlet pipe and the inlet pipe cover. The gas distribution mechanism is composed of two gas distribution plates stacked with each other, each gas distribution plate has a plurality of holes, and in the flow direction of the gas flow, the holes of one of the gas distribution plates are dislocated relative to the holes of the other gas distribution plate.

In this way, the gas flow that was originally affected by the pipelines and showed uneven flow rate may be re-adjusted through the two gas distribution plates, so that the flow field (i.e., flow rate) of the gas flow entering the chamber may be effectively uniformized. The hole of the gas distribution plate is a circular hole, and the diameter is preferably 9.5 mm to 12.7 mm. The dislocation distance between the corresponding two holes is preferably 0.7 times to 1 times the diameter, and the relative distance between the two gas distribution plates is preferably 4.7 times the diameter to 6.3 times the diameter. The hole may also be a non-circular hole. If the area thereof may be equal to the area of the aforementioned circular hole, it may have a uniformizing effect on the gas flow in the chamber.

Accordingly, through the adjustment of the gas distribution mechanism, the gas flow entering the chamber may move through the gas adsorption modules stably and at a uniform speed, thereby improving the capture efficiency of the gas adsorption modules. At the same time, the gas distribution mechanism is composed of two stacked gas distribution plates. The composition structure thereof is simple and is easy to disassemble and assemble. It may also achieve the purpose of providing effective gas capture for the flue system with a simple mechanism.

What is claimed is:

1. A gas capturing device, comprising:
an inlet pipe cover;
an outlet pipe cover;
a chamber, connected between the inlet pipe cover and the outlet pipe cover;
a plurality of gas adsorption modules, arranged with each other in a stacked manner in the chamber; and
a gas distribution mechanism, disposed between the inlet pipe cover and the chamber, wherein a gas flow enters the chamber from the inlet pipe cover by moving through the gas distribution mechanism, and enters the outlet pipe cover from the chamber after a specific gas of the gas flow is adsorbed by the gas adsorption modules, the gas distribution mechanism comprises two gas distribution plates stacked together along a flow direction of the gas flow, each gas distribution plate has a plurality of holes, and the holes of the two gas distribution plates are dislocated from each other along the flow direction of the gas flow.

2. The gas capturing device according to claim 1, wherein each gas adsorption module is plate-shaped and parallel to the flow direction of the gas flow, and the two gas distribution plates are perpendicular to the flow direction of the gas flow.

3. The gas capturing device according to claim 1, wherein the hole is a circular hole, and a diameter (D1) is 9.5 mm to 12.7 mm.

4. The gas capturing device according to claim 3, wherein a dislocation distance between the corresponding two holes of the two gas distribution plates is 0.7 times the diameter (D1) to 1 times the diameter (D1).

5. The gas capturing device according to claim 3, wherein a relative distance between the two gas distribution plates is 4.7 times the diameter (D1) to 6.3 times the diameter (D1).

6. The gas capturing device according to claim 1, wherein the holes are non-circular holes respectively, and an area of each hole is equal to an area of a circular hole with a diameter (D1) of 9.5 mm to 12.7 mm.

7. The gas capturing device according to claim 1, wherein the gas adsorption module is of a metal-organic framework (MOF) material.

8. The gas capturing device according to claim 1, wherein one end of the inlet pipe cover connected to the gas distribution mechanism gradually expands along the flow direction of the gas flow.

9. The gas capturing device according to claim 1, wherein one end of the outlet pipe cover connected to the chamber gradually contracts along the flow direction of the gas flow.

10. The gas capturing device according to claim 1, wherein the hole is a through hole of equal diameter.
